(19) United States
(12) Patent Application Publication
(10) Pub. No.: US 2025/0316083 A1
(43) Pub. Date: Oct. 9, 2025

(54) SYSTEMS AND METHODS FOR SPORTS TRACKING DATA COLLECTION, PROCESSING, AND CORRECTION

(71) Applicant: STATS LLC, Chicago, IL (US)

(72) Inventors: Gianluca CUCCO, Rivalta di Torino (IT); Laurent ALLAZZIO, Villeneuve-Loubet (FR); Jan FIKAR, Cerná v Pošumaví (CZ); Salvatore FRANCO, Carmagnola (IT); Michal SCHOVANEK, Praha (CZ); Sateesh PEDAGADI, London (GB)

(73) Assignee: STATS LLC, Chicago, IL (US)

(21) Appl. No.: 19/172,538

(22) Filed: Apr. 7, 2025

Related U.S. Application Data
(60) Provisional application No. 63/631,688, filed on Apr. 9, 2024.

(51) Int. Cl. G06V 20/40; G06T 7/20

(52) U.S. Cl. CPC G06V 20/42; G06T 7/20; G06V 2201/07

(57) ABSTRACT

A system may receive one or more data feeds for a sports event, wherein the one or more data feeds includes at least one data entry. The system may receive one or more video feeds for the sports event, wherein the one or more video feeds include event data. The system may identify a data feed error, wherein the data feed error is a difference between the at least one data entry and the event data in the one or more video feeds. The system may correct the data feed error, wherein correction of the data feed error includes altering the at least one data entry to be consistent with the event data.

### CROSS-REFERENCE TO RELATED APPLICATION

This application claims priority to U.S. Provisional Application No. 63/631,688, filed Apr. 9, 2024, which is hereby incorporated by reference in its entirety.

### TECHNICAL FIELD

Various aspects of the present disclosure relate generally to machine learning for sports applications, in particular various aspects relate to machine learning techniques for receiving and processing sports game data, including identification and correction of errors in sports game data.

### INTRODUCTION

Collecting, processing, and correcting tracking data, player data, team data, event data, and other data fields in a sports game can require a relatively large processing burden and may further require dozens of hours in human operator annotation and error correction. This burden is particularly acute in the context of processing data for thousands of sports events across hundreds of sports leagues, where timeliness and accuracy of data output is important. Efficiencies in automated and manual processing, correcting, and annotating of sports game data can thus reduce the computer processing load as well as any human operator time.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for processing and correcting data for a sports event, the method including: receiving, by a computing system, one or more data feeds for a sports event, wherein the one or more data feeds includes at least one data entry; receiving, by the computing system, one or more video feeds for the sports event, wherein the one or more video feeds include event data; identifying, by the computing system, a data feed error, wherein the data feed error is a difference between the at least one data entry and the event data in the one or more video feeds; and correcting, by the computing system, the data feed error, wherein correction of the data feed error includes altering the at least one data entry to be consistent with the event data.

In some aspects, the techniques described herein relate to a method, wherein the at least one data entry includes player identification data.

In some aspects, the techniques described herein relate to a method, wherein the at least one data entry includes player tracking data.

In some aspects, the techniques described herein relate to a method, wherein the at least one data entry includes jersey identification data.

In some aspects, the techniques described herein relate to a method, wherein the at least one data entry includes team association data.

In some aspects, the techniques described herein relate to a method, wherein the data feed error includes duplicate player identification data.

In some aspects, the techniques described herein relate to a method, wherein the data in the corrected data feed error is reincorporated into the one or more data feeds in real time.

In some aspects, the techniques described herein relate to a system for processing and correcting data for a sports event, the system including: a non-transitory computer readable medium configured to store processor-readable instructions; and a processor operatively connected to the non-transitory computer readable medium, and configured to execute the instructions to perform operations including: receiving one or more data feeds for a sports event, wherein the one or more data feeds includes at least one data entry; receiving one or more video feeds for the sports event, wherein the one or more video feeds include event data; identifying a data feed error, wherein the data feed error is a difference between the at least one data entry and the event data in the one or more video feeds; and correcting the data feed error, wherein correction of the data feed error includes altering the at least one data entry to be consistent with the event data.

In some aspects, the techniques described herein relate to a system, wherein the at least one data entry includes player identification data.

In some aspects, the techniques described herein relate to a system, wherein the at least one data entry includes player tracking data.

In some aspects, the techniques described herein relate to a system, wherein the at least one data entry includes jersey identification data.

In some aspects, the techniques described herein relate to a system, wherein the at least one data entry includes team association data.

In some aspects, the techniques described herein relate to a system, wherein the data feed error includes duplicate player identification data.

In some aspects, the techniques described herein relate to a system, wherein the data in the corrected data feed error is reincorporated into the one or more data feeds in real time.

In some aspects, the techniques described herein relate to a non-transitory computer readable medium configured to store processor-readable instructions, wherein when executed by a processor, the instructions perform operations including: receiving one or more data feeds for a sports event, wherein the one or more data feeds includes at least one data entry; receiving one or more video feeds for the sports event, wherein the one or more video feeds include event data; identifying a data feed error, wherein the data feed error is a difference between the at least one data entry and the event data in the one or more video feeds; and correcting the data feed error, wherein correction of the data feed error includes altering the at least one data entry to be consistent with the event data.

In some aspects, the techniques described herein relate to a non-transitory computer readable medium, wherein the at least one data entry includes player identification data.

In some aspects, the techniques described herein relate to a non-transitory computer readable medium, wherein the at least one data entry includes player tracking data.

In some aspects, the techniques described herein relate to a non-transitory computer readable medium, wherein the at least one data entry includes jersey identification data.

In some aspects, the techniques described herein relate to a non-transitory computer readable medium, wherein the at least one data entry includes team association data.

In some aspects, the techniques described herein relate to a non-transitory computer readable medium, wherein the data in the corrected data feed error is reincorporated into the one or more data feeds in real time.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an exemplary tracking and analytics environment, according to example embodiments.

FIG. 2 depicts an exemplary flow diagram for collecting, processing, and correcting a data feed for a sports event, according to example embodiments.

FIG. 3 depicts an exemplary embodiment of a method of collecting, processing, and correcting a data feed for a sports event, according to example embodiments.

FIG. 4 illustrates an exemplary image of a system for collecting, processing, and correcting a data feed for a sports event, according to example embodiments.

FIG. 5 illustrates an exemplary image of identifying players missing a player identification, according to example embodiments.

FIG. 6 illustrates an exemplary image of identifying a data feed error for duplicate player identification, according to example embodiments.

FIG. 7 illustrates exemplary embodiments of identifying and correcting data feed errors in a sports game, according to example embodiments.

FIG. 8 illustrates an exemplary image of a listing of clips in a sports game identified for correction, according to example embodiments.

FIG. 9 illustrates an exemplary image of a listing of sports games and associated clips identified for correction, according to example embodiments.

FIG. 10 illustrates an exemplary interface of a system for synchronizing video feeds for a sports event, according to example embodiments.

FIG. 11 illustrates an exemplary interface of a system for synchronizing video feeds for a sports event, according to example embodiments.

FIG. 12 illustrates an exemplary interface that identifies a main player, according to example embodiments.

FIGS. 13A-13E illustrate an exemplary interface of a system for calibration, according to example embodiments.

FIG. 14 illustrates an exemplary interface that includes a formation view, according to example embodiments.

FIG. 15 illustrates an exemplary interface of a system for identifying a potential error in a data feed for a sports event, according to example embodiments.

FIG. 16 illustrates an exemplary interface that includes a ground plane view, according to example embodiments.

FIG. 17 illustrates an example method for processing and correcting data for a sports event, according to example embodiments.

FIG. 18 depicts a flow diagram for training a machine learning model, according to example embodiments.

FIG. 19A is a block diagram illustrating an architecture of a computing system, according to example embodiments.

FIG. 19B is a block diagram illustrating a computing system, according to example embodiments.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION OF ASPECTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various aspects of the present disclosure relate generally to techniques for machine learning for sports applications. For instance, certain aspects include the training of machine learning models and the utilization of computer vision techniques for identifying errors in the data feed of a sports event, including errors in player identifications, time-ranged player identifications, player swaps, time-ranged player swaps, track deletion/correction, and time-ranged track deletion/correction.

Technical advantages of the disclosed techniques include accurately and efficiently identifying and/or correcting errors in a data feed associated with a sports game. By using the machine learning and computer vision techniques disclosed herein, such identifications and/or corrections may be generated in a more efficient, accurate, and faster manner while using less computational resources and less human operator input.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may be automatically correlated with a loss indicator for an opposing team. As another example, a score statistic may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and/or changes. For example, a sports machine learning model may be trained by modifying one or more weights, layers, nodes, biases, and/or synapses to associate given positions in reference to the playing surface of venue 106 and/or in reference to one or more agents 112A-N. As another example, a sports machine learning model may be trained by modifying one or more weights, layers, nodes, biases, and/or synapses to associate given movement or trends in reference to the playing surface of venue 106 and/or in reference to one or more agents 112A-N. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in viewing sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

While soccer and various aspects relating to soccer (e.g., identifying and correcting a misidentified player identification/jersey number) are described in the present aspects as illustrative examples, the present aspects are not limited to such examples. For example, the present aspects can be implemented for other sports or activities, such as American football, basketball, baseball, tennis, golf, cricket, rugby, team sports, individual sports, and so forth.

Systems and techniques disclosed herein are directed to efficient and accurate collection, processing, and correction of a data feed associated with a sports game, including identifying data feed errors and correcting errors via automated and/or human operator methods. These systems and techniques allow for improved data quality of a data feed associated with a sports event, permitting output to a consumer and/or to additional applications or systems for further processing.

Some approaches for collecting, processing, and correcting a data feed associated with a sports game require significant processing resources and/or human operator input to identify errors in a data feed and/or to subsequently correct errors in a data feed. This resource-load is particularly acute where such processing is required for thousands of sports games across a variety of leagues and sports, and specifically, where timeliness and accuracy are important factors in an output product. For example, a soccer game utilizing computer vision technologies may require from 50 to 100 hours of human and/or computer-assisted annotation time to produce 100% quality tracking data. According to systems and techniques disclosed herein, this processing time may be reduced to, for example, approximately 8-14 hours or less for approximately 100% quality tracking data. Such processing time may be reduced even further where machine learning methods allow for automated identification, processing, and correction of data feed errors.

According to systems and techniques disclosed herein, an interface may automatically be generated for a human operator to analyze, approve, and/or correct data feed errors identified by the system, wherein this interface is generated based upon a received data feed (e.g., a JSON file) that is updated in real-time based on automated correction input from the system and/or from human operator corrections and validation. The received data feed may be based on tracking data and/or event data, as discussed herein. The tracking data and/or event data may be generated based on a broadcast feed or in-venue feed.

According to systems and techniques disclosed herein, the collection, processing, and correction of a data feed may be supported simultaneously across multiple games and with multiple automated or human operators providing continuous, real-time corrections and/or validation of corrections, wherein such corrections are incorporated into the data feed continuously in real-time. Similarly, these corrections may be immediately reflected in interfaces and applications utilized across automated and human operators connected to the same sports game or to multiple sports games via a network, locally, or via a client-server application, where processing progress is synced in real-time to maximize the performance in terms of production time and processing efficiency.

According to systems and techniques disclosed herein, the interface generated for collection, processing, and correction of a data feed may include fast interaction features, including shortcut keys and automation flows to speed up interactions with the user interface where, for example, a human operator may provide validation to corrections and/or provide corrections.

According to systems and techniques disclosed herein, the interface may automatically identify and highlight data feed errors and provide suggestions for correction and/or validation by a human operator, where necessary, based on machine learning and computer vision techniques. The application may also provide automated identification and correction of data feed errors based on machine learning and computer vision techniques. If necessary, a human operator may then validate such automated corrections where, for example, the application identifies a low-confidence level concerning a correction.

According to systems and techniques disclosed herein, where a human operator is involved in identification, correction, validation, or other processing of a data feed, efficiency statistics for the operator may be collected to analyze a human operator's efficiency, accuracy, and performance.

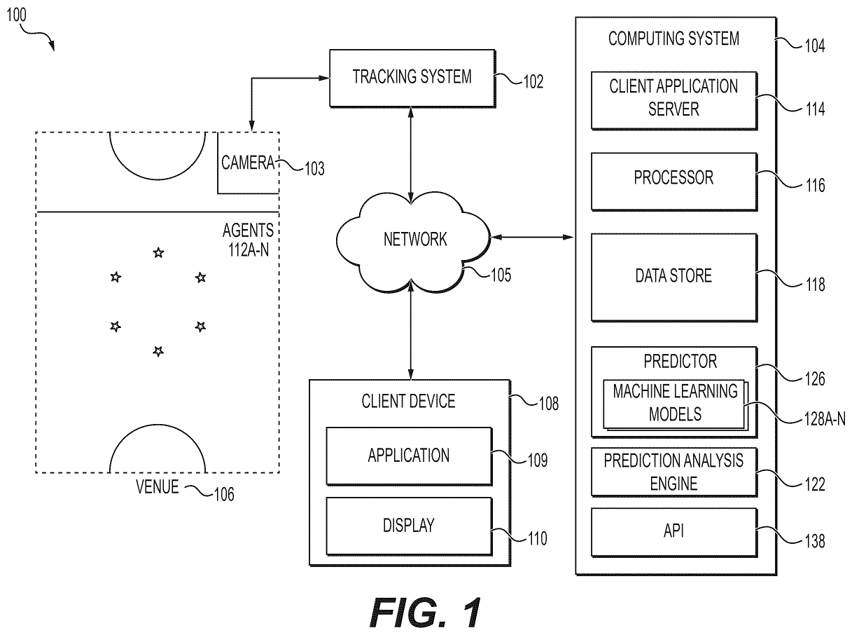

FIG. 1 is a block diagram illustrating a tracking and analytics environment 100, according to example aspects. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models. In an example, environment 100 and its components collect a data feed (e.g., tracking data, player identification data) and a video feed, and environment 100 and its components process, correct, and/or validate the data feed for accuracy in conformity with the visual information presented in a video feed. The environment 100 and its components may automatically identify and correct data feed errors and/or the environment 100 and its components may identify errors and generate suggested corrections for entry and validation by a human operator. Similarly, the human operator may further provide a quality control validation of the automatic identification and correction of data feed errors.

Tracking system 102 may be positioned in, adjacent to, or near a venue 106, or additionally or alternatively, tracking system 102 may access a video feed and/or broadcast video feed via network 105, wherein network 105 may connect tracking system 102 to one or more cameras 103 or to one or more video feeds. Non-limiting examples of venue 106 include stadiums, fields, pitches, and courts. Venue 106 includes agents 112A-N (players). Tracking system 102 may be configured to record the motions and actions of agents 112A-N on the playing surface, as well as one or more other objects of relevance (e.g., ball, referees, etc.).

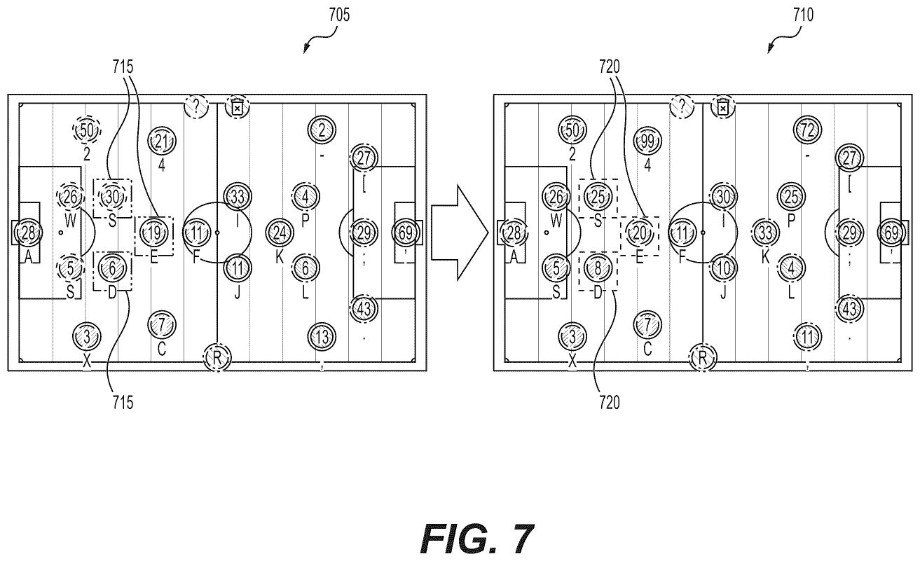

In some aspects, tracking system 102 may be an optically-based system using, for example, camera 103. While one camera is depicted, additional cameras are possible. For example, a system of six stationary, calibrated cameras, which project the three-dimensional locations of players and the ball onto a two-dimensional overhead view of the field/court may be used, and exemplary model of such view is illustrated in FIG. 7.

In another example, a mix of stationary and non-stationary cameras may be used to capture motions of all agents 112A-N on the playing surface as well as one or more objects of relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file.

In some embodiments, the tracking system 102 may provide a video feed, via network 105, to one or more machine learning models of computing system 104, to generate tracking data. The one or more machine learning models may identify players and/or objects in the video feed and convert them to digital representations. The digital representations of the players and/or objects and their respective positions may be tracked to identify tracking data such as movement data (e.g., changes in the positions), changes in movement, trends, etc. Such information may be used by a prediction module (e.g., predictor 126 or prediction analysis engine 122) to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, video feeds may be used to generate tracking data which may further be used to determine event data corresponding to certain sports events.

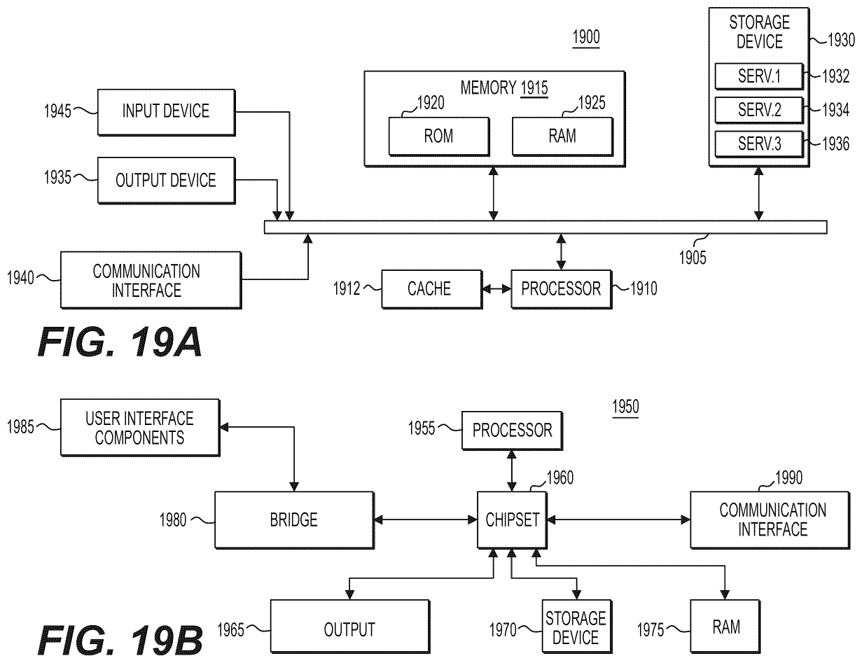

As explained above, tracking system 102 may be configured to communicate with computing system 104 via network 105. Computing system 104 may be configured to manage and analyze the data captured by tracking system 102. Computing system 104 may include a web client application server 114, a pre-processing agent 116, a data store 118, and a third-party Application Programming Interface (API) 138. An example of computing system 104 is depicted with respect to FIGS. 19A and 19B.

Pre-processing agent 116 may be configured to process data retrieved from data store 118 or tracking system 102 prior to input to predictor 126.

Data store 118 may be configured to store different kinds of data. In an example, data store 118 can store raw tracking data received from tracking system 102. The data store 118 can include historical game data, live data, features, team data, player data, tracking data, corrected data, and/or prediction data. The historical game data can include historical team and player data for one or more sporting events. Live data can include data received from tracking system 102, e.g., in real time, and/or live data can include corrected data that is incorporated into the data store in real time.

The feature vectors can be generated for a specific sporting event (e.g., a soccer match) or a combination of events. Feature vectors can include player and/or team features.

Predictor 126 includes one or more machine-learning models 128A-N. For example, predictor 126 may utilize one or more video feeds to identify visual attributes for each player and/or team and determine whether errors exist in a corresponding pre-processed data feed. For example, where a player identification tracking timeline includes multiple entries for single player, predictor 126 may identify such an error and automatically correct such error or may generate suggestions for correcting such an error. Predictor 126 may thus accurately identify and correct errors in a data feed associated with a sports game to improve the associated data quality.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, operators, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

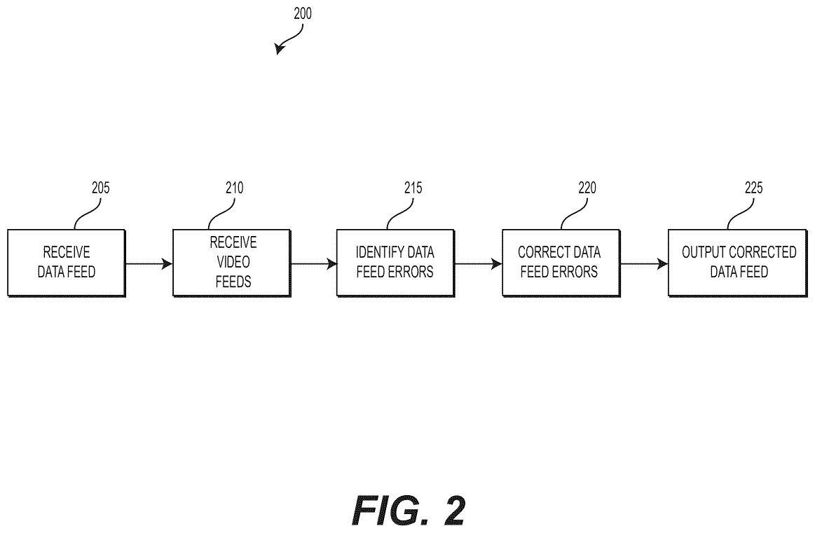

Referring now to FIG. 2, an exemplary flow diagram 200 is shown for collecting, processing, and correcting errors in a data feed associated with a sports event, according to example embodiments. As shown in flow diagram 200 of FIG. 2, at step 205 a data feed (e.g., a JSON file) may be received, wherein the data feed is associated with a sports game and may include multiple data fields/entries. For example, such data fields may include: player identification data, time-ranged player identification data, tracking data, team formation data, player role data, lighting condition data, etc. The data feed may include data for each frame of a video feed and/or based on different time intervals (e.g., approximately every millisecond).

At step 210, at least one video feed may be received from one or more cameras 103 located at or within venue 106, and additionally or alternatively, the video feed(s) may be received from a broadcast feed that is accessed, for example, via a network 105, a local data store, or similar communications means. The video feed may include additional data and/or additional associated data types or visual appearance data, including tracking data from tracking system 102, or other data received from the video feed or resulting from preprocessing of the video feed or of the tracking data from tracking system 102. The video feed may further include event data, wherein the event data may include, for example, visual appearance data, video frame data, data obtained from computer-vision techniques applied to the video feed, or other data obtained from the video feed.

According to embodiments, event data may be generated manually or may be generated by a computing system in real time (e.g., within approximately 30 seconds of an event occurring), as discussed herein. Event data may correspond to event based actions (e.g., scores, passes, formation changes, plays, fouls, penalties, etc.) during a given match. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning model trained to receive, as an input, a game file or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

At step 215, data feed errors are identified, if present, for specific frames and/or clips from the at least one video feed. Such errors may include misidentified players, missing player identification, incorrect/missing team formation data, misidentified/missing player role data, duplicate player data, misidentified or missing tracking data, incorrect visual tracking/position indicators, etc., wherein such identifications may be made based on, for example, data inconsistencies, incongruence between a data feed and automated or human analysis of a video feed, etc.

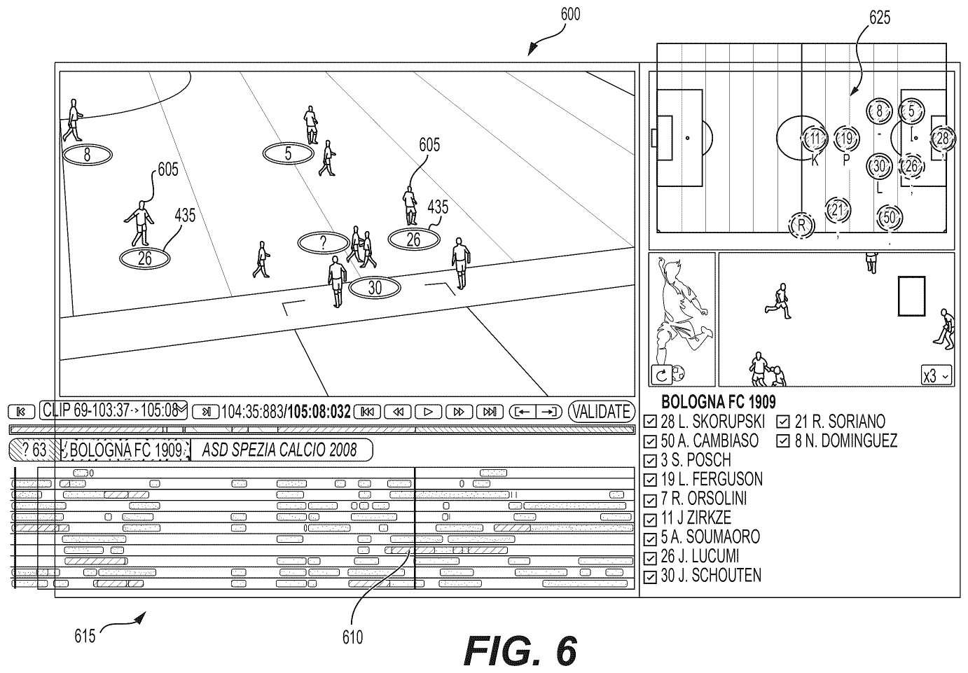

For example, and as illustrated in FIG. 6, where a data feed includes duplicate player identifications (e.g., two different players identified as jersey number 26), an error may be identified for correction. The systems disclosed herein may determine this error based on the data feed being identified as violating a rule (e.g., having more than one player being identified as the same player). This error may be corrected automatically and/or the error may be identified for a human operator's corrective action where, a timeline 615 may indicate an error for a specific player's player timeline 610. Similarly, for example, where tracking information data for a player contains illogical data (i.e., a player represented as incorrectly appearing on opposite sides of a field within milliseconds), the tracking information data may be identified as including an error for correction. Data may also be identified for errors where the data does not meet a threshold level of accuracy (e.g., a player identification does not meet a threshold level of confidence). As one example, if the system identifies duplicate players with the same jersey number on a single team, the system may prompt a human operator to correct the jersey numbers in order to validate a video clip, and in turn, prevent the human operator from advancing to a new clip without validating the clip. Similarly, such correction may be made automatically where a machine learning model implements or suggests corrections, where the machine learning model has been trained on a collection of cropped visual player images, including jersey numbers for each player and correspondence between visual player images and jersey numbers. The suggested correction may be automatically generated by analyzing the tracking data to track the positions of one or more players and correlating the identified positions with the positions of the identified duplicate players, to determine the correct identified player from the identified duplicate players. The suggested correction may further be automatically generated using predictor 126 which predicts the location of one or more players and compares the predicted position with the position indicated in the data feed, to suggest a corrected position based on the prediction. Such predictions may be implemented, for example, when one or more players are outside video feed frames for a period of time, or are occluded from view in a video feed, such that their actual position is unknown.

As a further example, where a data feed includes misidentified players (e.g., a player is associated with the wrong player ID, jersey number, etc.), an error may be identified for correction. This error may be corrected automatically and/or the error may identified for a human operator's corrective action where a timeline 615 may indicate an error for a specific player's player timeline 610. For example, where visual appearance data may be incongruent with tracking data or player identification data, the tracking data or player identification data may be identified as including an error for correction. Data may also be identified for errors where the data does not meet a threshold level of accuracy (e.g., a player identification does not meet a threshold level of confidence and/or player identification prediction methods predict that a player may be associated with two or more player identifications). As one example, when a player has been potentially misidentified by a tracking system, a human operator may cross-check the temporal appearance of the player against a collage of cropped visual player images, allowing the human operator to quickly scan the various appearances of a player to determine whether the player has been misidentified. Similarly, such correction may be made automatically where a machine learning model implements or suggests corrections, where the machine learning model has been trained on a collection of cropped visual player images.

As a further example, where a data feed includes missing player information, an error may be identified for correction. This error may be corrected automatically and/or the error may be identified for a human operator's corrective action where a tracking disk 435, main video feed 415, timeline 615, or other component of the visual feed may provide identification of the error. For example, where computer vision techniques identify a player on a playing field and that player is not associated with a player identification, jersey number, etc., the tracking data associated with that player may be identified as including an error for correction. Data may also be identified for errors where the data does not meet a threshold level of accuracy (e.g., a player identification does not meet a threshold level of confidence such that a player remains unidentified).

As a further example, where a data feed includes incorrect and/or missing team formation data, an error may be identified for correction. This error may be corrected automatically and/or the error may be identified for a human operator's corrective action, where for example, a formation view 430 or other component of a visual feed may provide identification of the error. For example, where computer vision techniques and/or processing of tracking data identify incongruences between tracking data, visual appearance data, etc. and team formation data (or missing team formation data), the team formation data may be identified as including an error for correction. Data may also be identified for errors where the data does not meet a threshold of accuracy (e.g., tracking data does not meet a threshold level of confidence for the actively-utilized team formation data).

As a further example, where a data feed includes misidentified and/or missing player role data (e.g., midfielder, defender, goalkeeper, etc.), an error may be identified for correction. This error may be corrected automatically and/or the error may be identified for a human operator's corrective action, where for example, a tracking disk, main video feed 415, timeline 615, or other component of a visual feed may provide identification of the error. For example, where computer vision techniques and/or processing of tracking data identify incongruences between player role data and player identification and/or team formation data, the player role data may be identified as including an error for correction. Such an error may also be identified for correction where a player is identified as missing associated player role data. This may also occur where, for example, one or more player's roles changes during a sports event (e.g., a midfielder and defender switch positions during a match) or where a player substitution occurs. Data may also be identified for errors where the data does not meet a threshold level of accuracy (e.g., tracking data for a player does not meet a threshold level of confidence for the player role currently associated with a player).

As a further example, where a data feed includes misidentified or missing tracking data for a player or includes incorrect or missing visual tracking/position indicators, an error may be identified for correction. This error may be corrected automatically and/or the error may be identified for a human operator's corrective action, where for example, computer vision techniques have recognized the presence of an individual on the playing field, but the player is not associated with tracking data or is associated with incorrect tracking data. Similarly, for example, a player may be displayed in the main video feed 415 without an associated tracking disk or the associated tracking disk may be incorrect. Data may also identified for errors where the data does not meet a threshold level of accuracy (e.g., no tracking data meets a threshold level of confidence for it to be associated with a specific player). For example, where a player's tracking data indicates a player has “beamed” from one location to a different location in an impossibly short time period, as determined by the system or a model, the system or model may highlight this incorrect tracking information. The system may highlight the erroneous section of this tracking data with a specific color on the tracking timeline, permitting a human operator to quickly scan the player timeline to determine the erroneous tracking data for identification and/or correction.

At step 220, data feed errors are corrected automatically and/or via human operator input. For example, where a data feed includes duplicate player identifications, a video feed may be analyzed to provide or suggest corrections to the data feed using, for example, computer vision and machine learning techniques to accurately identify players in a game (e.g., by jersey number identification, facial recognition, etc.).

Errors may also be identified automatically to a human operator, where automated correction suggestions may be generated and provided to an operator for efficient correction entry. For example, where a tracking disk 435 (see, e.g., FIG. 6) is missing or incorrectly located, this error may be automatically identified and corrected, or alternatively, the error may be identified to a human operator with (or without) a suggested correction for the human operator to add or adjust the position of the tracking disk 435 to an accurate location. Upon entry and/or validation of such correction, corresponding data (e.g., player identification, player role) may be concurrently updated in real time, which in turn, may improve accuracy and quality of corresponding data (e.g., tracking data for the player). For example, where a data feed includes a misidentified player, correction of the player data may automatically fill-in or complete any gaps in tracking data for the player (e.g., previous position vs. current position). In some embodiments, a suggested correction may be automatically generated by one or more system components and/or a machine learning model analyzing tracking data to track the positions of one or more players and correlating the identified positions with the positions of identified duplicate players, to determine the correct identified player from the identified duplicate players. The suggested correction may further be automatically generated using predictor 126 which may predict the location of one or more players and compare the predicted position with the position indicated in a data feed, to suggest a corrected position based on the prediction. Such predictions may be implemented, for example, when one or more players are outside video feed frames for a period of time, or are occluded from view in a video feed, such that their actual position is unknown.

Similarly, automated or human operator corrections may also pass through an optional validation step, wherein a human operator validates the accuracy of a correction before outputting the corrected data feed. According to one embodiment, such validation may be required where a confidence-level for a correction does not meet an accuracy or quality threshold.

Any corrections are instantly and continuously applied to the data stored locally, on a client-server, or other storage means. Additionally, where a human operator is present, the operator may validate and output the data to the data feed, wherein the corrected and validated data may be instantly available to additional operators and/or consumers of the data feed.

For example, a machine learning model may be trained on historical data feeds, data sets, and/or in-game data to generate correction predictions. A machine learning model may receive, as an input, a data feed from a sporting event, wherein the data feed may be compared to, for example, historical data feeds to assess correlation of certain data objects (e.g., a play, player positions, object positions, team formation data, etc.) and generate predictions based on these correlations. Further, such predictions may be assessed against a certain threshold level of confidence to determine whether a prediction is to be utilized in a correction.

At step 225, following correction of data feed errors and the optional step of validating such corrections, the corrected data feed (or data fields within the feed) is output for real-time integration with the data feed associated with the specific game. The real time integration may include generating corrected overlays including player identification such that the overlays are presented proximate to a corresponding player's player position. The real time integration may include generating a corrected visual representation of players and/or objects such that the visual representation is output via a display (e.g., as shown in FIG. 6).

It will be appreciated by one of ordinary skill in the art that the method of FIG. 2 may be adapted to applications for processing and correcting multiple games simultaneously and in real-time.

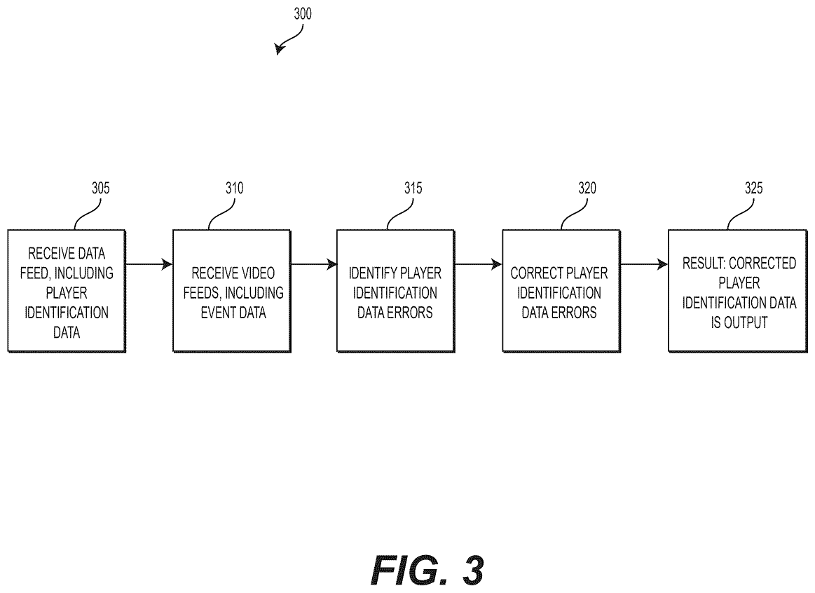

Referring now to FIG. 3, an exemplary embodiment of a method 300 of collecting, processing, and correcting a data feed for a sports event is shown, according to example embodiments.

At step 305, a data feed is received, wherein the data feed includes player identification data associated with each player.

At step 310, one or more video feeds are received, including event data, wherein the event data may include, for example, visual appearance data, video frame data, data obtained from computer-vision techniques applied to the video feed, or other data obtained from the video feed. The event data may include annotated or tagged play information, player information, object information, and/or the like.

At step 315, player identification data errors are identified where, for example, a specific player is listed as a duplicate (e.g., a player identification is associated with more than one player).

At step 320, the player identification error is corrected. It will be appreciated that this step may be completed according to one or more appropriate means of error correction and may involve automated correction and/or human operator correction.

For example, computer vision and machine learning techniques may be utilized to process the video feed for visual appearance data to accurately determine the player identification of the player subject to the error. According to one embodiment, facial recognition, jersey number recognition, or visual appearance data, or other recognition data may be utilized to correct the player identification by accurately matching visual appearance data to reference data for that player's visual appearance data. Such methods may further involve the use of tracking data information that may be utilized to determine a player identification based on tracking information over a period of time. For example, where a player identification is determined based on a high level of confidence, tracking data for that player may be utilized to identify that player at an earlier and/or a later time where the player's visual appearance has become occluded (e.g., the time period at which a player may have been misidentified).

The correction may proceed to a validation process, where a human operator, for example, may perform a quality control analysis for accuracy of the correction. According to one embodiment, this validation process may only be required where the correction does not meet a threshold level of confidence.

At step 325, the corrected player identification data is output, wherein it may be integrated in real-time with the data feed associated with the specific game.

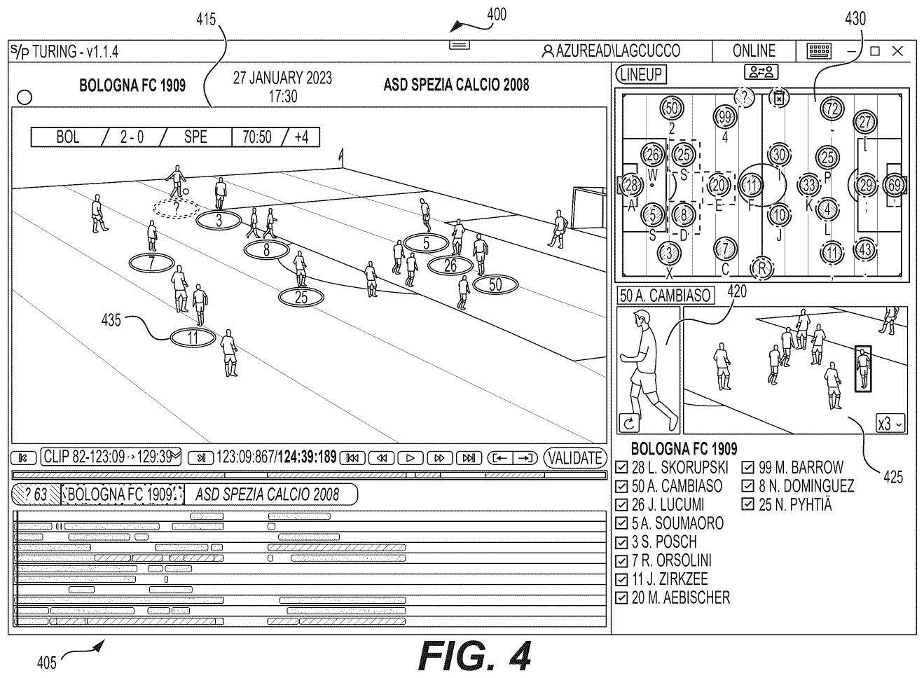

Referring now to FIG. 4, an exemplary image 400 is illustrated for a system for collecting, processing, and correcting a data feed for a sports event, according to example embodiments. The interface includes a representation of a data feed integrated with one or more video feeds, wherein such information represents data fields for potential error identification, processing, correction, and/or validation, wherein such steps may be performed automatically and/or by a human operator.

A main video feed 415 represents a visual feed from one or more cameras 103 or from a broadcast feed, wherein such video feed may be accessed from a local storage device, via a network 105, and/or via broadcast feed. Each tracked player includes a tracking disk 435 associated with the player. A human operator may interact with the tracking disk 435 to access previews of the player at different times of the video feed. Further, a human operator may interact with the tracking disk 435 to make changes to the data feed and/or data field(s) associated with the tracking disk 435, including, for example, changes to jersey number, player identification, player role, etc.

A player timeline 405 illustrates the current video time progression, displays the occurrence of each player in the video frame, highlights the jersey density, and displays icons of events. For example, in a particular frame or time, jersey density represents the number of players that are identified in the field of view of the video frame, and accordingly, where tracking data (or other data) is present for a player. Gaps in a specific player's player timeline 405 represents a frame or time where a player is not identified, for example, where a player is not within the field of view or where a player is incorrectly identified as missing from the field of view and/or misidentified. Similarly overlaps in a specific player's timeline 405 may represent a duplicate player identification, as shown, for example in FIG. 6. Such gaps may trigger a correction action, as discussed herein.

Where a human operator is involved in processing, the operator may be restricted to viewing a player timeline 405 representing only those players assigned to the human operator. Visibility may also be turned on and off to allow an operator to focus on one player or certain groups of players. The player timeline 405 further allows a human operator to efficiently switch between identified errors in the player timeline 405 for potential correction and/or validation of automated corrections.

Similarly, the player timeline 405 may include event and/or error icons representing identified errors, including, for example, a portion of a player's player timeline 405 where the player is identified in more than once in a frame (e.g., duplicate identification), as illustrated in FIG. 6. These event and/or error icons may alert a human operator of an error for potential correction and/or provide automated suggestions for potential correction. The player timeline 405 may also identify issues such as inconsistent player positions and potential close positions, where a potential visual occlusion may be present due to a separate player obscuring the visual appearance of a player.

Formation view 430 represents a current team(s) formation employed by each team at the time of the video frame displayed in main video feed 415, wherein the current team formation is automatically synchronized with the current video displayed in the main video feed 415. This synchronization permits a human operator to efficiently check the player role, player identification, etc. via a comparison of the formation view 430 and the main video feed 415. Individual players may also be highlighted where they are identified as, for example, being assigned duplicate player identification data, where such identification may assist human operators in correction and/or validation of correction of such identified errors. There are also interface shortcuts for each player, permitting a human operator to quickly and efficiently select a player for further processing.

Second video view 425 represents a cropped and zoomed tactical view of the video frame which may, for example, be used to preview the context of a specific player's position on the field, wherein an operator may manually adjust the zoom levels. According to implementations disclosed herein, such a second video view 425 may be automatically generated and provided to an operator based on the identification or selection of a gap, as discussed herein. Such automatic provision of the cropped and zoomed tactical view may allow an operator to more efficiently view a relevant portion of the feed to implement or approve a corrective action.

Zoomed player view 420 represents a further cropped and zoomed view of a selected player with an assigned jersey number and player identification appearing above the zoomed player view 420. According to implementations disclosed herein, such a zoomed player view 420 may be automatically generated and provided to an operator based on the identification or selection of a gap, as discussed herein. This view may allow for a more accurate and efficient identification of a player for potential correction of an error associated with the player and/or for validation of an automated correction of an error associated with the player. Zoomed player view 420 may, for example, also represent a reference image for a player, wherein such reference image may be utilized for player identification, player role, etc. purposes in connection with computer vision and machine learning applications of player identification. The reference image may be automatically or manually updated to represent a clearer image of a player including, for example, improved visibility jersey number or other visual appearance data.

The system environment 100 (e.g., computing system 104 and/or client device 108) may include an input device (e.g., a keyboard or controller), wherein certain shortcuts are mapped to input buttons on the input device, allowing for efficient input into and manipulation of system environment 100, including a visual feed. For example, certain mapped shortcuts may permit an operator to select various players and/or player roles/positions, assign/change player role/positions, swap player identification data, select/change/delete a player track, select a player timeline, delete a player timeline, change team formations/player positions, navigate video clips (e.g., clips marked for correction and/or quality review), mark portions of a video feed, adjust the position of a tracking disk 435, play/pause/rewind/fast forward a video feed,

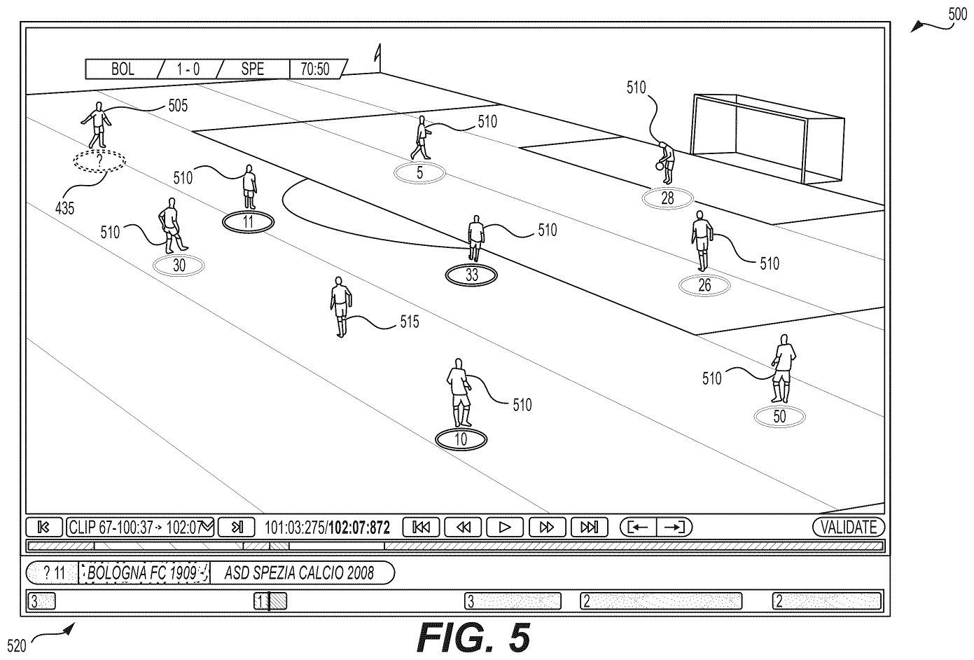

Referring now to FIG. 5, an exemplary image 500 of identifying players missing a player identification is illustrated, in accordance with an embodiment.

For example, identified players 510 are represented as being associated with a player identification, and a refereeing official 515 has been identified as a non-player. According to one embodiment, a missing player identification error may be presented where a player has been identified as an unidentified player 505, where the unidentified player 505's associated tracking disk 435 displays a question mark, representing the missing player identification. This missing player may correspond to a gap in a specific player timeline in the tracking timeline 520.

Referring now to FIG. 6, an exemplary image 600 of identifying a data feed error for duplicate player identification is illustrated, in accordance with an embodiment

According to one embodiment, a timeline 610 error may be automatically identified within the player timeline 615, wherein a single player has been identified as appearing in the video frame more than once. For example, two players 605 have each been identified as “Player 26” as shown in the numeric representation in tracking disks 435. This error may be corrected automatically or via human operator intervention according to the methods and techniques disclosed herein.

Ground plane 2D view 625 may also be generated in addition to formation view 430, wherein ground plane 2D view 625 illustrates player positions on the field and may incorporate predicted or observed future trajectories to permit determination of potential visual occlusion of players over a period of time, for example, where correction of player identification and/or player role may be required.

Referring now to FIG. 7, exemplary embodiments of identifying and correcting data feed errors in a sports game is illustrated, in accordance with an embodiment. An uncorrected formation view 705 is illustrated in which player errors 715 have been identified for certain players (e.g., player identification error, player role error, player jersey number identification error, etc.). A corrected formation view 710 illustrates a representation of player formations that have been corrected either automatically and/or via human operator, wherein player identifications 720 have been corrected according to systems and techniques disclosed herein.

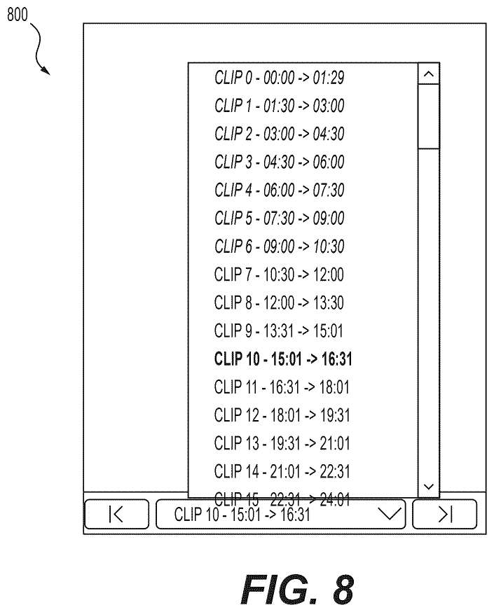

Referring now to FIG. 8, an exemplary image 800 of a listing of clips identified for correction is illustrated, according to example embodiments.

A human operator may navigate a game video feed by selecting corresponding clips, wherein clips may represent specific video time coverage or may correspond with specific game events (e.g., goals, red cards, penalties, substitutions, etc.) or automatically identified potential data feed errors (e.g., events identified as requiring validation of an automated correction or requiring human operator correction).

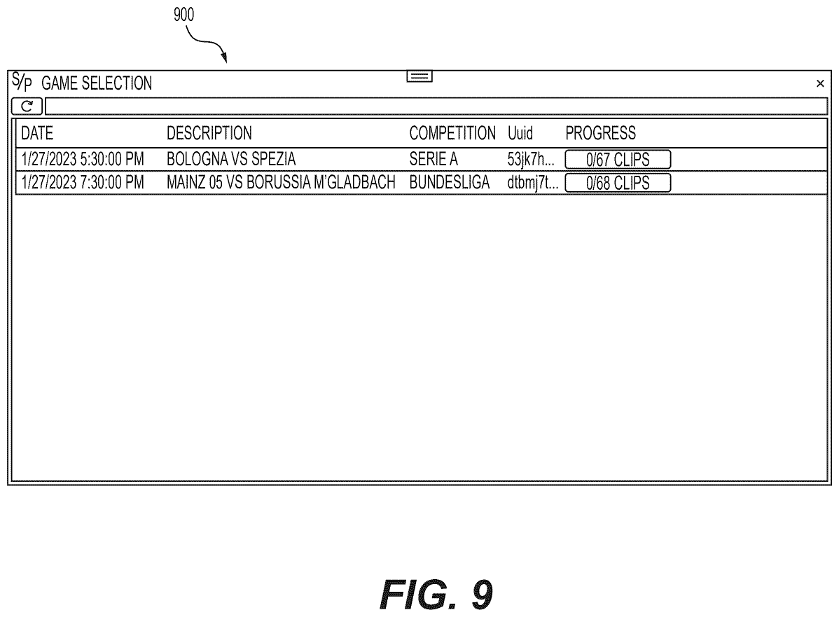

Referring now to FIG. 9, an exemplary image 900 of a listing of sports games and clips identified for correction is illustrated, according to example embodiments.

A human operator may navigate multiple game video feeds by selecting corresponding game video feeds, wherein such game video feeds may represent, for example, games in which potential data feed errors have been identified and in which human operator input is required for validation of an automated correction or for correction of an error by the human operator. It will be appreciated that a human operator may further navigate a selected sports game via navigation of specific clips, as illustrated in FIG. 8.

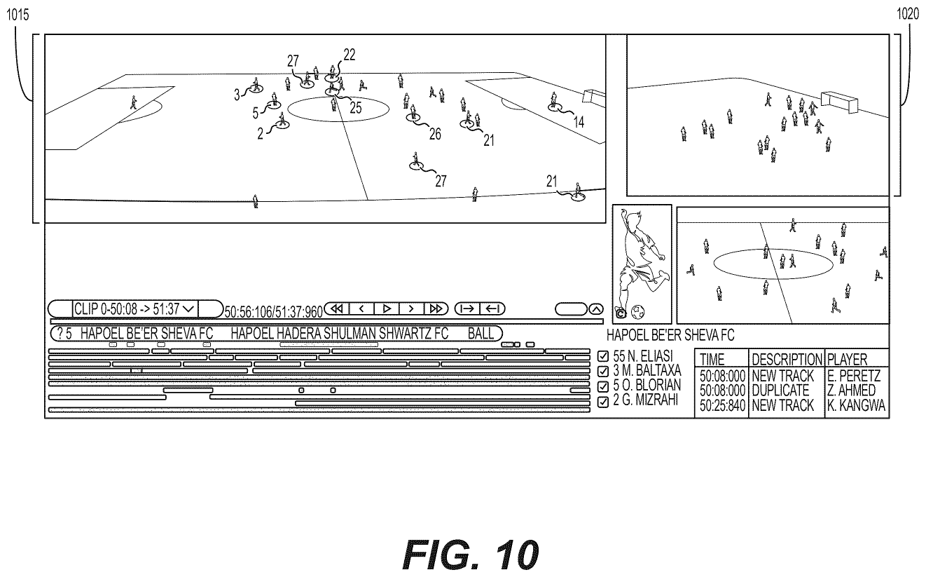

FIG. 10 illustrates an exemplary interface (e.g., a user interface or image) 1000 of a system for synchronizing video feeds for a sports event, according to example embodiments. In some aspects, the interface 1000 may be an embodiment of the image 400, 500, or 600 of FIGS. 4, 5, and 6, respectively. In some embodiments, the interface 1000 may be generated by computing system 104 or client device 108.

As shown in FIG. 10, the interface 1000 may include a main video feed 1015, which may represent a visual feed from one or more cameras 103. For example, the main video feed 1015 may represent a plurality of images stitched together (or merged), where each of the plurality of images is captured by a respective camera 103. Further, in some embodiments, the main video feed 1015 may depict a panoramic view of a venue, field, pitch, or the like. As shown in FIG. 10, the main video feed 1015 may depict one or more players, referees, balls, or other objects, and each of the one or more players, referees, balls, or other objects may be associated with tracking data, event data, or other sports related data. In some embodiments, the main video feed 1015 may be accessed from a local storage device or via a network 105.

The interface 1000 may also include a broadcast video feed 1020, which may represent a visual feed from a broadcast feed. In some aspects, the broadcast video feed 1020 may be re-positioned within, or removed from, the interface 1000, by a human operator. Further, a human operator (or machine learning algorithm, computer vision algorithm, or other algorithm) may zoom in on the broadcast video feed 1020 to view or determine detailed information regarding, for example, a player's appearance, jersey number, or position on a field (or pitch). In some embodiments, a human operator (or machine learning algorithm, computer vision algorithm, or other algorithm) may determine tracking data or event data based on the broadcast video feed 1020 (e.g., by zooming in on the broadcast video feed 1020 to view or determine information related to tracking or an event). In some aspects, such tracking data or event data may be associated with the main video feed 1015, or may augment tracking data or event data associated with the main video feed 1015. For example, where the main video feed 1015 depicts a player, and where the depicted player is not associated with tracking data (e.g., indicating a position of the depicted player on a field), the depicted player may be associated with tracking data derived (or determined) from an image of the player in the broadcast video feed 1020. As another example, where the main video feed 1015 depicts a player, and where the depicted player is not identified, the depicted player may be associated with a jersey number (or other form of identification) derived (or determined) from an image of the player in the broadcast video feed 1020. Thus, in some aspects, the broadcast video feed 1020 may be used to improve or augment data associated with the main video feed 1015.

In some aspects, a human operator, machine learning algorithm, computer vision algorithm, or other algorithm (e.g., of computing system 104 or client device 108) may be used to synchronize the main video feed 1015 with the broadcast video feed 1020. Put differently, the main video feed 1015 may be associated with the broadcast video feed 1020 such that when the two video feeds are played concurrently, the two video feeds depict video frames of events that occur at the same time or same rate. For example, when the main video feed 1015 and the broadcast video feed 1020 are synchronized, and when the main video feed 1015 depicts a player passing a ball, the broadcast video feed 1020 may also depict the player passing the ball (optionally from a different angle or perspective from that of the main video feed 1015). In some embodiments, to synchronize the main video feed 1015 with the broadcast video feed 1020, one or more portions of the broadcast video feed 1020 (e.g., of advertisements, or video that does not correspond to, or is not reflected in, the main video feed 1015) may need to be omitted or disregarded. In some aspects, one or more of such portions may represent offset(s). For example, where the broadcast video feed 1020 includes a five-minute advertisement but the main video feed 1015 does not, to synchronize the broadcast video feed 1020 with the main video feed 1015, the five-minute advertisement may need to be omitted from the broadcast video feed 1020 (or disregarded or treated as an offset). Further, the video frame of the broadcast video feed 1020 that immediately follows the end of the five-minute advertisement may be associated with a time (e.g., 00:00), and a video frame of the main video feed 1015 that corresponds to the time may be identified and associated with the time and/or the video frame of the broadcast video feed 1020. In some aspects, omitting (or disregarding) one or more portions of the broadcast video feed 1020 to synchronize the broadcast video feed 1020 with the main video feed 1015 may represent a form of calibration. In some embodiments, where the main video feed 1015 and the broadcast video feed 1020 include videos frames of the same game, such calibration may be performed manually (e.g., by a human operator) or automatically, one or more times during the game. For example, where the main video feed 1015 and the broadcast video feed 1020 include videos frames of a soccer game, the calibration may be performed only once during the soccer game (e.g., at halftime).

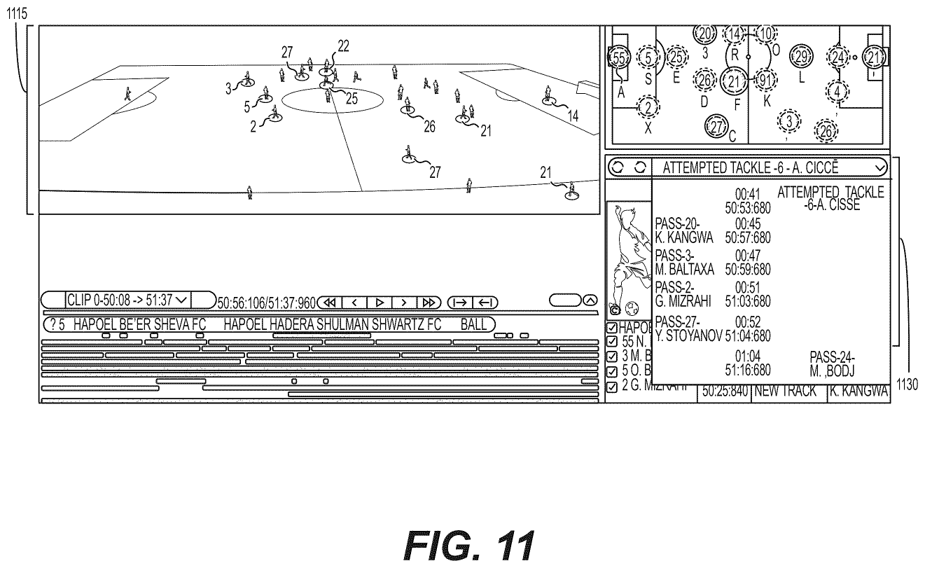

FIG. 11 illustrates an exemplary interface 1100 of a system for synchronizing video feeds for a sports event, according to example embodiments. In some aspects, the interface 1100 may be an embodiment of the interface 1000. Further, the interface 1000 may be generated by computing system 104 or client device 108.

As shown in FIG. 11, the interface 1100 may include a main video feed 1115, which may be an embodiment of the main video feed 1015 of FIG. 10. In some aspects, a human operator (or machine learning algorithm, computer vision algorithm or other algorithm) may interact with the main video feed 1115 by zooming in or zooming out of the main video feed 1115, or adjusting the main video feed 1115 to display additional imagery (or video) in a particular direction (e.g., left, right, up, or down). Further, a human operator (or machine learning algorithm, computer vision algorithm, or other algorithm) may interact with the main video feed 1115 by selecting or deselecting one or more players, balls, or other objects depicted in the main video feed 1115. In some embodiments, a human operator (or machine learning algorithm, computer vision algorithm, or other algorithm) may select a team depicted in the main video feed 1115, and responsive to the selection, the main video feed 1115 may be modified to show all players (e.g., on a field) of the selected team. Further, in some embodiments, a human operator (or machine learning algorithm, computer vision algorithm, or other algorithm) may unselect a player depicted in the main video feed 1115, and responsive to the un-selection, the main video feed 1115 may be modified to show (or focus on) one or more other players.

As shown in FIG. 11, the interface 1100 may also include an event menu 1130. In some aspects, the event menu 1130 may depict event data of a game, where the game is depicted in the main video feed 1115. In some embodiments, a human operator (or machine learning algorithm, computer vision algorithm or other algorithm) may select event data (e.g., an entry or listing) in the event menu 1130, and responsive to the selection, video of an event corresponding to the event data may be played in the main video feed 1115. In some embodiments, the event menu 1130 may represent a drop-down menu. Further, the event menu 1130 may include event data such as annotated or tagged play information, player information, object information, and/or the like.

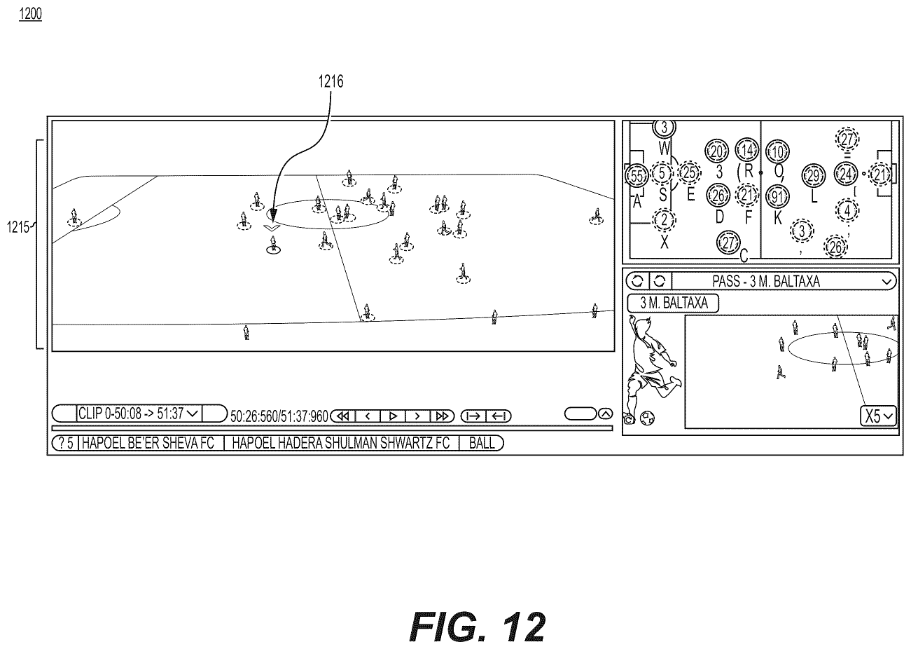

FIG. 12 illustrates an exemplary interface 1200 that identifies a main player, according to example embodiments. In some aspects, the interface 1200 may be an embodiment of the interface 1000 or 1100. Further, the interface 1000 may be generated by computing system 104 or client device 108. As shown in FIG. 12, the interface 1200 may include a main video feed 1215, which may be an embodiment of the main video feed 1015 or 1115. In some embodiments, where the main video feed 1215 depicts one or more players of a game, an arrowhead or other symbol may be used to represent a player who is in control of a ball (or other object), or a player who is significant, in the main video feed 1215. Such a player may also be referred to herein as a “main actor.” For example, as shown in FIG. 12, a main actor is signified by an arrowhead 1216.

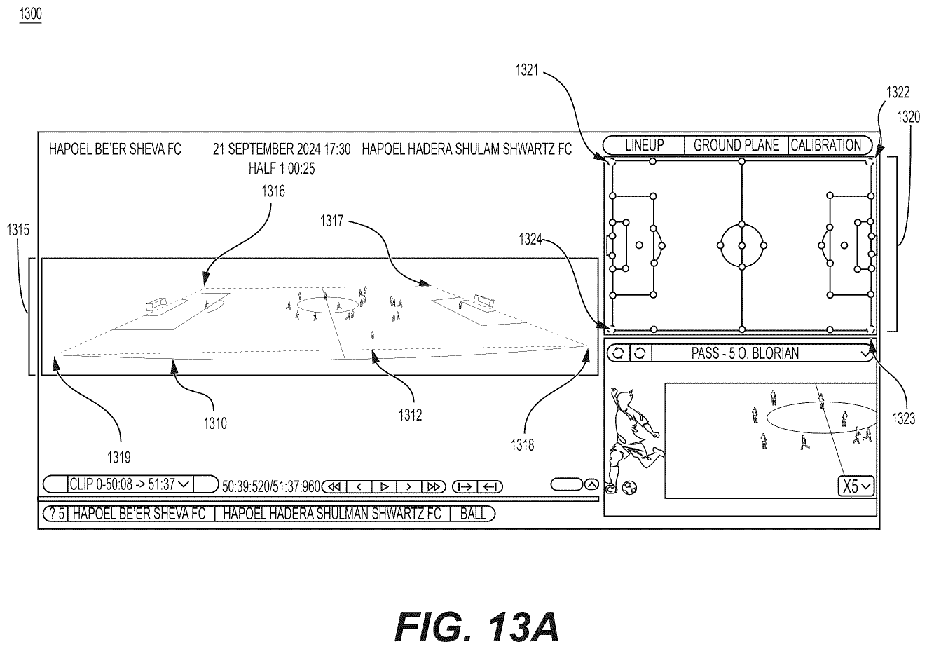

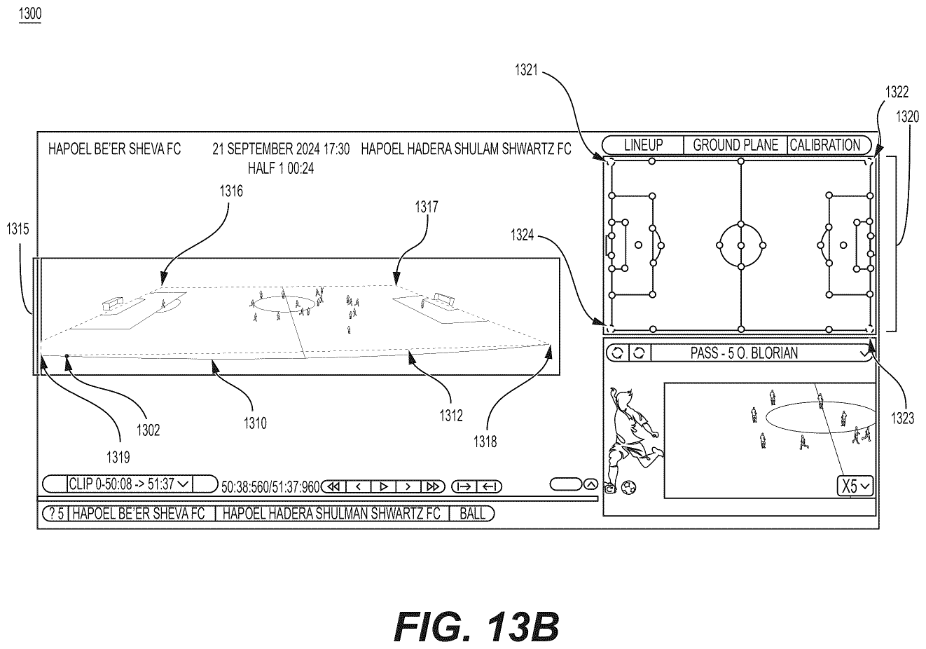

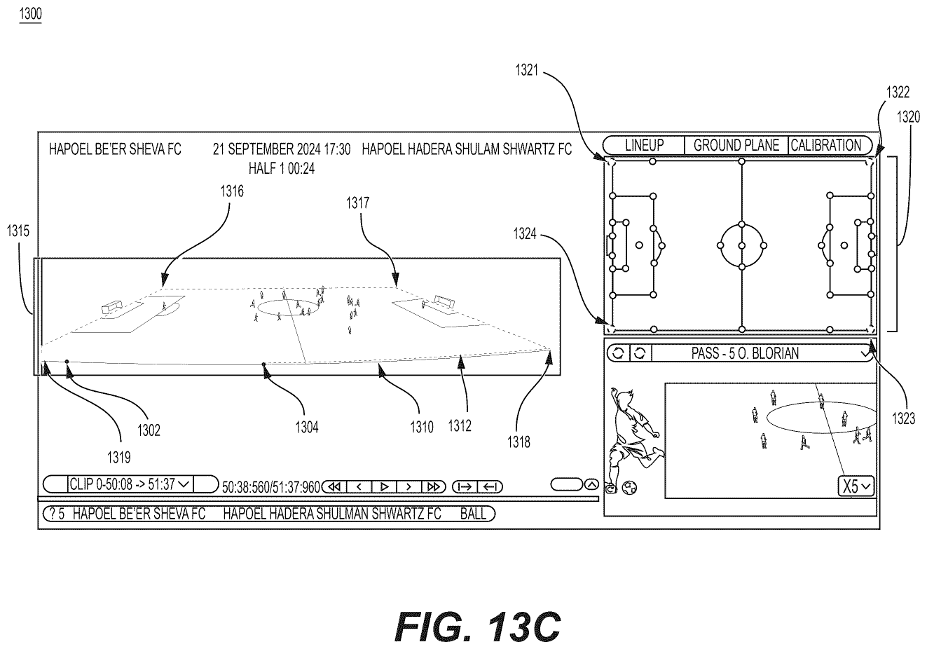

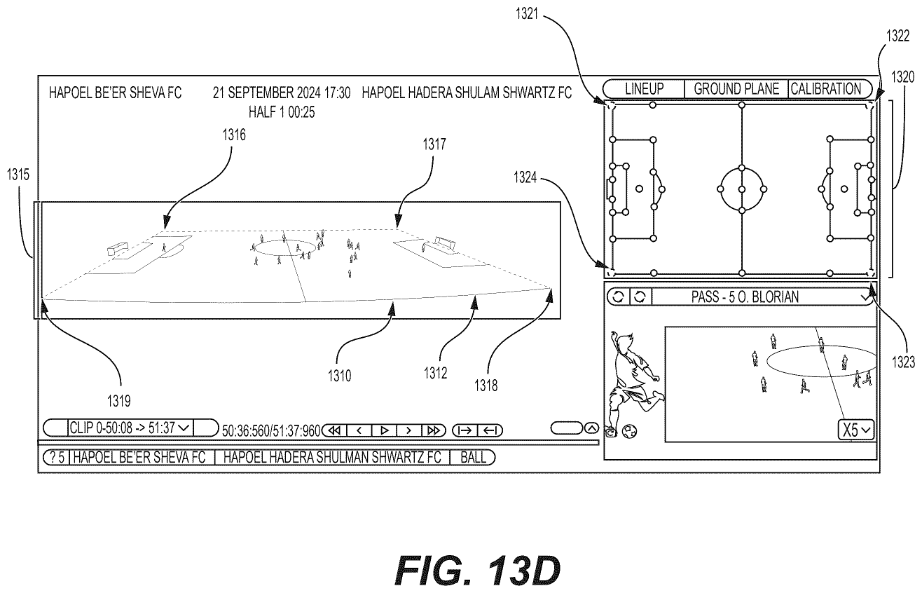

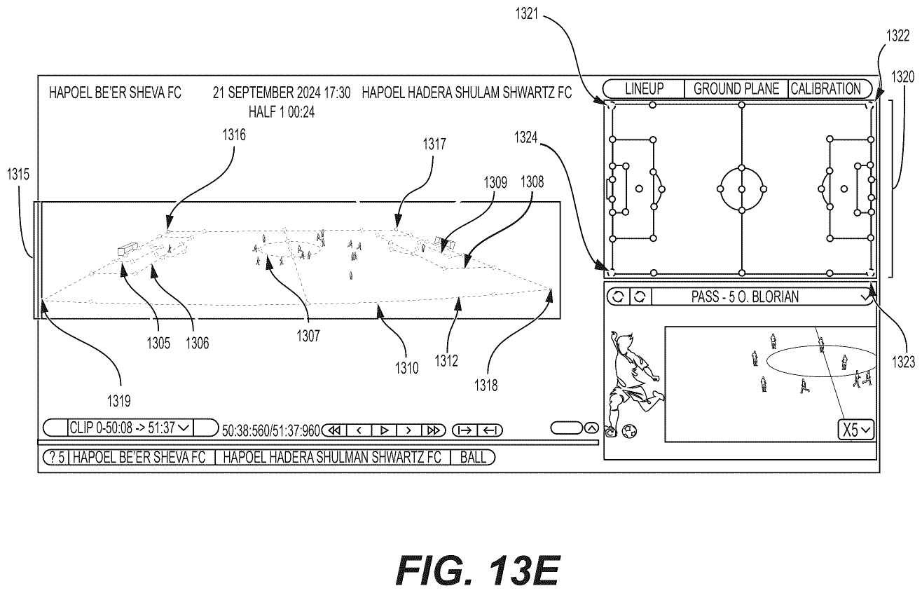

FIG. 13A illustrates an exemplary interface 1300 of a system for calibration, according to example embodiments. In some aspects, the interface 1300 may be an embodiment of the interface 1000, 1100, or 1200. Further, the interface 1300 may be generated by computing system 104 or client device 108, for example.

As shown in FIG. 13A, the interface 1300 may include a main video feed 1315, which may be an embodiment of the main video feed 1015, 1115, or 1215. In some embodiments, the main video feed 1015 may represent a venue, field, pitch, or the like. The interface 1300 may also include a ground plane view 1320, which may be an embodiment of formation view 430 or ground plane 2D view 625. In some aspects, the ground plane view 1320 may represent, from a different perspective, the venue, field, pitch, or the like, that is represented in the main video feed 1315. In some aspects, the ground plane view 1320 may represent the venue, field, pitch, or the like, with correct proportions (e.g., no errors or distortions).

In some embodiments, the main video feed 1315 may include multiple videos (or images) that are captured by one or more cameras 103, and stitched together. In some cases, because of this, lines, players, objects, or the like, that are depicted in the main video feed 1315 may appear distorted. For example, as shown in FIG. 13A, the line 1310, which represents a boundary of a soccer field, appears curved due to distortion. The line 1310 may also be referred to herein as the “distorted line 1310.” However, to account for (or omit) this distortion, the main video feed 1315 may be calibrated using, for example, the proportions of the ground plane view 1320 for reference. To perform the calibration, a human operator may select each of the corners of the ground plane view 1320 (e.g., 1321, 1322, 1323, and 1324), and each of the corners of the soccer field depicted in the main video feed 1315 (e.g., 1316, 1317, 1318, and 1319). In some embodiments, the system may subsequently associate these corners. That is, the system may determine that the corner 1316 corresponds to the corner 1321; the corner 1317 corresponds to the corner 1322; the corner 1318 corresponds to the corner 1323; and the corner 1319 corresponds to the corner 1324. Subsequently, the system may detect that the line 1310 is distorted, and cause the undistorted line 1312 (e.g., a straight line that represents an undistorted version of the line 1310) to appear in the main video feed 1315. To continue the calibration, the human operator may select one or more points along the distorted line 1310, and as the human operator makes these selection(s), the undistorted line 1312 may begin to merge with the distorted line 1310. For example, as shown in FIG. 13B, where the human operator selects a point 1302 of the distorted line 1310, a portion of the undistorted line 1312 may subsequently merge with the distorted line 1310. Similarly, as shown in FIG. 13C, where the human operator subsequently selects a point 1304 of the distorted line 1310, another portion of the undistorted line 1312 may then merge with the distorted line 1310. In some embodiments, the human operator may subsequently select additional point(s) along the undistorted line 1312, until the undistorted line 1312 is fully merged (or overlaps) with the distorted line 1310, as shown in FIG. 13D. Once the undistorted line 1312 is fully merged with the distorted line 1310, the system may re-calculate the positions of other lines on the soccer field in the main video feed 1315 (e.g., using proportions of the ground plane view 1320 for reference), in order to calibrate such lines. For example, as shown in FIG. 13E, the system may re-calculate the positions, and display the recalculated positions, of lines 1305-1309.

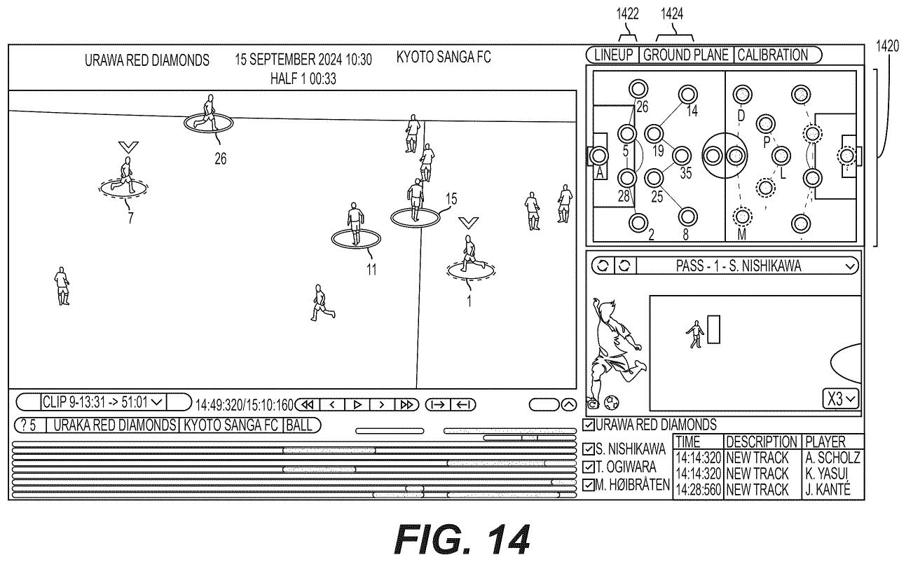

FIG. 14 illustrates an exemplary interface 1400 that includes a formation view 1420, according to example embodiments. The interface 1400 may be an embodiment of the interface 1000, 1100, 1200, or 1300. Further, the formation view may be an embodiment of the formation view 430. In some aspects, the interface 1400 may be generated by computing system 104 or client device 108, for example.

As shown in FIG. 14, formations of players on a field (or pitch) are indicated in the formation view 1420 using one or more lines. More specifically, a blocking formation 1422 is indicated by straight lines that connect each of the defensive players 26, 5, 28, and 2. As another example, a blocking formation 1424 is indicated by straight lines that connect each of the mid-field players 14, 19, 35, 25, and 8. In some aspects, such lines may be used to track formations of players as a game is played and represented in the formation view 1420.

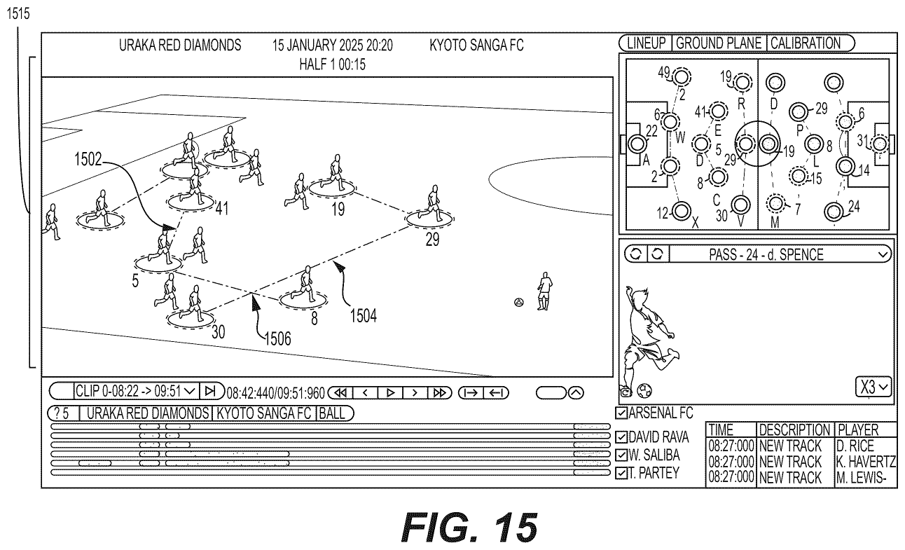

FIG. 15 illustrates an exemplary interface 1500 of a system for identifying a potential error in a data feed for a sports event, according to example embodiments. The interface 1500 may be an embodiment of the interface 1000, 1100, 1200, 1300, or 1400. As shown in FIG. 15, the interface 1500 may include a main video feed 1515, which may be an embodiment of the main video feed 1015, 1115, 1215, or 1315. In some aspects, the interface 1500 may be generated by computing system 104 or client device 108.

In some embodiments, where the main video feed 1515 depicts players of a team, lines may be used to connect various players in order show one or more formations (e.g., a blocking formation as discussed above with respect to FIG. 14). In some aspects, where such formation lines cross one another, this crossing may represent that there are distortions or errors associated with positions of players represented in the main video feed 1515. For example, as shown in the main video feed 1515, lines 1502 connect players 41, 5, and 8 (and represent a formation), and lines 1504 connect players 19, 29, and 30 (and represent another formation). However, lines 1502 and 1504 cross at point 1506. In some embodiments, a human operator, machine learning algorithm, computer vision algorithm, or other algorithm may detect that the lines 1502 and 1504 cross at the point 1506, and subsequently determine whether there are one or more errors or distortions associated with the positions of the players in the main video feed 1515. Upon detecting such error(s) or distortion(s), the human operator, machine learning algorithm, computer vision algorithm, or other algorithm may correct the error(s) or distortion(s) using one or more techniques described herein.

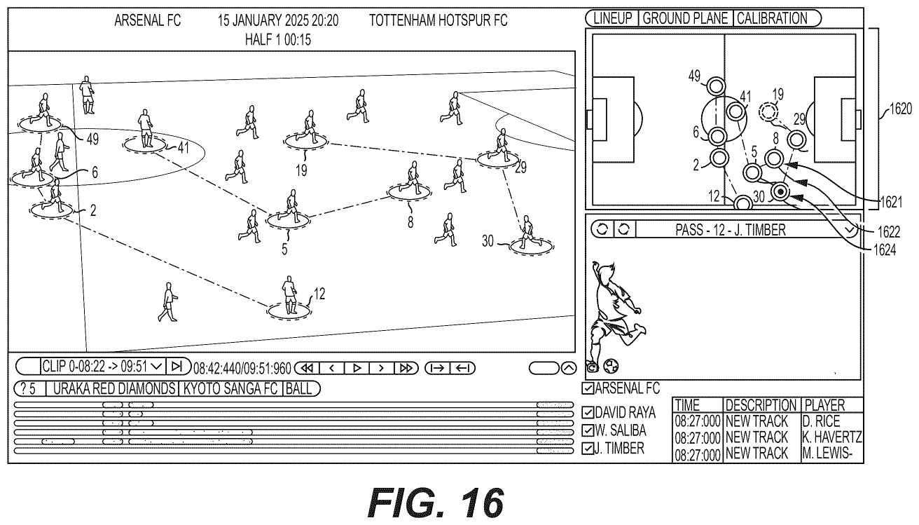

FIG. 16 illustrates an exemplary interface 1600 that includes a ground plane view 1620, according to example embodiments. The interface 1600 may be an embodiment of the interface 1000, 1100, 1200, 1300, 1400, or 1500. The ground plane view 1620 may be an embodiment of the ground plane view 1320. In some aspects, the interface 1600 may be generated by computing system 104 or client device 108. In some embodiments, the ground plane view 1620 may include an icon 1624, which may represent the location of an event (e.g., a pass, kick, or the like) on a field (or pitch) depicted in the ground plane view 1620. Further, the ground plane view 1620 may include actual future positions, or predicted future positions, of players on the field (or pitch). For example, the ground plane view 1620 may depict a position of a player 1621 on the field, and the predicted future position (or actual future position) 1622 of the player 1621 on the field. In some embodiments, the predicted future position 1622 of the player 1621 may be determined using predictor 126 or prediction analysis engine 122.

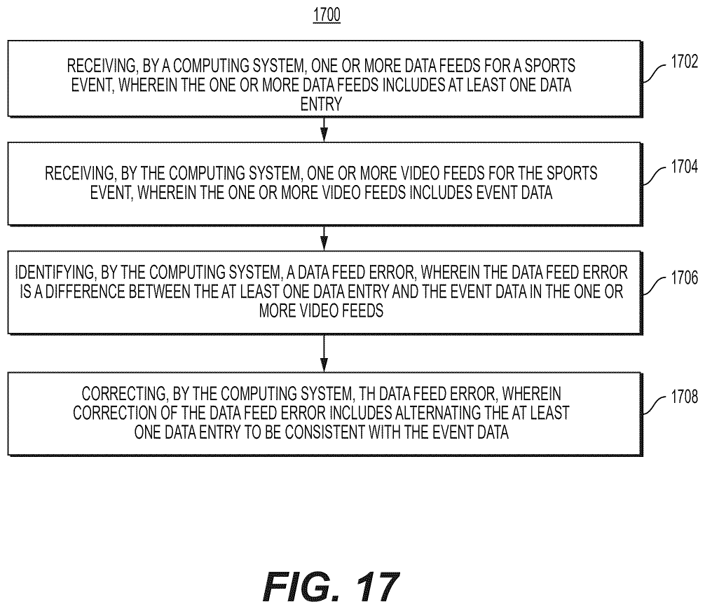

FIG. 17 depicts a flow diagram of a method 1700 for processing and correcting data for a sports event, according to example embodiments. In some aspects, the method 1700 may be performed by the computing system 104.

As shown in FIG. 17, the method 1700 may include receiving, by a computing system (e.g., the computing system 104), one or more data feeds for a sports event, wherein the one or more data feeds includes at least one data entry (1702). In some embodiments, the at least one data entry may include player identification data, player tracking data, jersey identification data, and/or team association data.

The method 1700 may include receiving, by the computing system, one or more video feeds for the sports event, wherein the one or more video feeds includes event data (1704). The method 1700 may include identifying, by the computing system, a data feed error, wherein the data feed error is a difference between the at least one data entry and the event data in the one or more video feeds (1706). In some embodiments, the data feed error may include duplicate player identification data.

The method 1700 may include correcting, by the computing system, the data feed error, wherein correction of the data feed error includes altering the at least one data entry to be consistent with the event data (1708). In some embodiments, the data in the corrected data feed error may be reincorporated into the one or more data feeds in real time.

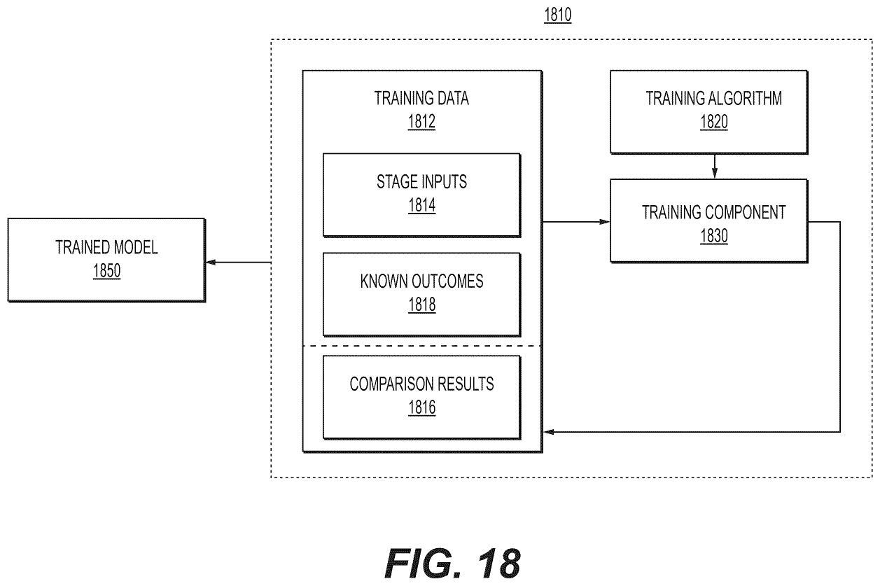

FIG. 18 depicts a flow diagram for training a machine learning model, according to example embodiments. As shown in flow diagram 1810 of FIG. 18, training data 1812 may include one or more of stage inputs 1814 and known outcomes 1818 related to a machine learning model to be trained. The stage inputs 1814 may be from any applicable source including a component or set shown in the figures provided herein. The known outcomes 1818 may be included for machine learning models generated based on supervised or semi-supervised training. An unsupervised machine learning model might not be trained using known outcomes 1818. Known outcomes 1818 may include known or desired outputs for future inputs similar to or in the same category as stage inputs 1814 that do not have corresponding known outputs.

The training data 1812 and a training algorithm 1820 may be provided to a training component 1830 that may apply the training data 1812 to the training algorithm 1820 to generate a trained machine learning model 1850. According to an implementation, the training component 1830 may be provided comparison results 1816 that compare a previous output of the corresponding machine learning model to apply the previous result to re-train the machine learning model. The comparison results 1816 may be used by the training component 1830 to update the corresponding machine learning model. The training algorithm 1820 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1810 may be a trained machine learning model 1850.

It will be appreciated that training of a machine learning model may incorporate, partially or wholly, elements of collection, identification, correction, and validation of errors in a data feed, as described above with reference to FIGS. 1-17. For example, training of a machine learning model may include training sets covering multiple games for multiple teams and players, including training on identification of numerous data fields (e.g., player identification, play role prediction, team formation, team identification, etc.)

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 19A illustrates an architecture of computing system 1900, according to example embodiments. The computing system 1900 may also be referred to herein as “system 1900.” System 1900 may be representative of at least a portion of computing system 104 or client device 108. One or more components of system 1900 may be in electrical communication with each other using a bus 1905. System 1900 may include a processing unit (CPU or processor) 1910 and a system bus 1905 that couples various system components including the system memory 1915, such as read only memory (ROM) 1920 and random access memory (RAM) 1925, to processor 1910. System 1900 may include a cache of high-speed memory connected directly with, in close proximity to, or integrated as part of processor 1910. System 1900 may copy data from memory 1915 and/or storage device 1930 to cache 1912 for quick access by processor 1910. In this way, cache 1912 may provide a performance boost that avoids processor 1910 delays while waiting for data. These and other modules may control or be configured to control processor 1910 to perform various actions. Other system memory 1915 may be available for use as well. Memory 1915 may include multiple different types of memory with different performance characteristics. Processor 1910 may include any general purpose processor and a hardware module or software module, such as service 1 1932, service 2 1934, and service 3 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction with the computing system 1900, an input device 1945 may represent any number of input mechanisms, such as a microphone for speech, a touch-sensitive screen for gesture or graphical input, keyboard, mouse, motion input, speech and so forth. An output device 1935 (e.g., display) may also be one or more of a number of output mechanisms known to those of skill in the art. In some instances, multimodal systems may enable a user to provide multiple types of input to communicate with computing system 1900. Communications interface 1940 may generally govern and manage the user input and system output. There is no restriction on operating on any particular hardware arrangement and therefore the basic features here may easily be substituted for improved hardware or firmware arrangements as they are developed.

Storage device 1930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1925, read only memory (ROM) 1920, and hybrids thereof.

Storage device 1930 may include services 1932, 1934, and 1936 for controlling the processor 1910. Other hardware or software modules are contemplated. Storage device 1930 may be connected to system bus 1905. In one aspect, a hardware module that performs a particular function may include the software component stored in a computer-readable medium in connection with the necessary hardware components, such as processor 1910, bus 1905, output device 1935, and so forth, to carry out the function.

FIG. 19B illustrates a computer system 1950 having a chipset architecture that may represent at least a portion of computing system 104. Computer system 1950 may be an example of computer hardware, software, and firmware that may be used to implement the disclosed technology. System 1950 may include a processor 1955, representative of any number of physically and/or logically distinct resources capable of executing software, firmware, and hardware configured to perform identified computations. Processor 1955 may communicate with a chipset 1960 that may control input to and output from processor 1955. In this example, chipset 1960 outputs information to output 1965, such as a display, and may read and write information to storage device 1970, which may include magnetic media, and solid-state media, for example. Chipset 1960 may also read data from and write data to RAM 1975. A bridge 1980 for interfacing with a variety of user interface components 1985 may be provided for interfacing with chipset 1960. Such user interface components 1985 may include a keyboard, a microphone, touch detection and processing circuitry, a pointing device, such as a mouse, and so on. In general, inputs to system 1950 may come from any of a variety of sources, machine generated and/or human generated.

Chipset 1960 may also interface with one or more communication interfaces 1990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1955 analyzing data stored in storage device 1970 or RAM 1975. Further, the machine may receive inputs from a user through user interface components 1985 and execute appropriate functions, such as browsing functions by interpreting these inputs using processor 1955.

It may be appreciated that example systems 1900 and 1950 may have more than one processor 1910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for processing and correcting data for a sports event, the method comprising:
receiving, by a computing system, one or more data feeds for a sports event, wherein the one or more data feeds includes at least one data entry;
receiving, by the computing system, one or more video feeds for the sports event, wherein the one or more video feeds includes event data;
identifying, by the computing system, a data feed error, wherein the data feed error is a difference between the at least one data entry and the event data in the one or more video feeds; and
correcting, by the computing system, the data feed error, wherein correction of the data feed error includes altering the at least one data entry to be consistent with the event data.

2. The method of claim 1, wherein the at least one data entry includes player identification data.

3. The method of claim 1, wherein the at least one data entry includes player tracking data.

4. The method of claim 1, wherein the at least one data entry includes jersey identification data.

5. The method of claim 1, wherein the at least one data entry includes team association data.

6. The method of claim 1, wherein the data feed error includes duplicate player identification data.

7. The method of claim 1, wherein the data in the corrected data feed error is reincorporated into the one or more data feeds in real time.

8. A system for processing and correcting data for a sports event, the system comprising:
a non-transitory computer readable medium configured to store processor-readable instructions; and
a processor operatively connected to the non-transitory computer readable medium, and configured to execute the instructions to perform operations comprising:
receiving one or more data feeds for a sports event, wherein the one or more data feeds includes at least one data entry;
receiving one or more video feeds for the sports event, wherein the one or more video feeds includes event data;
identifying a data feed error, wherein the data feed error is a difference between the at least one data entry and the event data in the one or more video feeds; and
correcting the data feed error, wherein correction of the data feed error includes altering the at least one data entry to be consistent with the event data.

9. The system of claim 8, wherein the at least one data entry includes player identification data.

10. The system of claim 8, wherein the at least one data entry includes player tracking data.

11. The system of claim 8, wherein the at least one data entry includes jersey identification data.

12. The system of claim 8, wherein the at least one data entry includes team association data.

13. The system of claim 8, wherein the data feed error includes duplicate player identification data.

14. The system of claim 8, wherein the data in the corrected data feed error is reincorporated into the one or more data feeds in real time.

15. A non-transitory computer readable medium configured to store processor-readable instructions, wherein when executed by a processor, the instructions perform operations comprising:
receiving one or more data feeds for a sports event, wherein the one or more data feeds includes at least one data entry;
receiving one or more video feeds for the sports event, wherein the one or more video feeds includes event data;
identifying a data feed error, wherein the data feed error is a difference between the at least one data entry and the event data in the one or more video feeds; and
correcting the data feed error, wherein correction of the data feed error includes altering the at least one data entry to be consistent with the event data.

16. The non-transitory computer readable medium of claim 15, wherein the at least one data entry includes player identification data.

17. The non-transitory computer readable medium of claim 15, wherein the at least one data entry includes player tracking data.

18. The non-transitory computer readable medium of claim 15, wherein the at least one data entry includes jersey identification data.

19. The non-transitory computer readable medium of claim 15, wherein the at least one data entry includes team association data.

20. The non-transitory computer readable medium of claim 15, wherein the data in the corrected data feed error is reincorporated into the one or more data feeds in real time.
